(19) United States
(12) Patent Application Publication
(10) Pub. No.: US 2020/0214282 A1
(43) Pub. Date: Jul. 9, 2020

(54) LIGHT-BASED FLY REPELLENTS AND METHODS OF MAKING SAME

(71) Applicant: Raymond C. Batten, II, College Station, TX (US)

(72) Inventor: Raymond C. Batten, II, College Station, TX (US)

(21) Appl. No.: 16/824,332

(22) Filed: Mar. 19, 2020

Related U.S. Application Data
(63) Continuation of application No. 14/505,330, filed on Oct. 2, 2014, now abandoned.
Application No. 14/505,330 is a continuation of application No. 13/222,905, filed on Aug. 31, 2011, now abandoned.
(60) Provisional application No. 61/402,924, filed on Sep. 8, 2010.

(51) Int. Cl. A01M 29/10; A01M 29/08

(52) U.S. Cl. CPC A01M 29/10; A01M 29/08

(57) ABSTRACT

Light-based fly repellents may refract light and disturb the optical perception of houseflies. Light may be refracted and the optical perception of houseflies may be disturbed through use of a clear or lightly color-tinted liquid enclosed in a sealed clear or lightly color-tinted body housed in a frame. When natural light (such as sunlight) or light available from other sources (such as a lamp or porch light) is placed in contact with the repellent, houseflies may be influenced not to aggregate around the area where the repellent may be positioned.

### CROSS-REFERENCE TO RELATED APPLICATIONS

This application claims priority to and is a continuation of U.S. Non-Provisional patent application Ser. No. 14/505,330 filed Oct. 2, 2014, which claims priority to, and is a continuation of, U.S. Non-Provisional patent application Ser. No. 13/222,905 entitled “LIGHT-BASED FLY REPELLENTS AND METHODS OF MAKING SAME” filed on Aug. 31, 2011, which claims the benefit of Provisional Application No. 61/402,924, entitled “CLEAR OR COLOR-TINTED LIQUID ENCLOSED IN SEALED CLEAR OR COLOR-TINTED PLASTIC (HARD AND/OR SOFT) CONTAINER FOR USE AS LIGHT-BASED FLY REPELLENT,” filed on Sep. 8, 2010, all of which are incorporated by reference in their entirety.

### TECHNICAL FIELD

The present disclosure is generally directed to fly repellents, and more specifically, to light-based fly repellents and methods of making same.

### BACKGROUND

Houseflies, also referred to as Musca domestica, are the most common of all domestic flies, accounting for about 90% of all flies that may be found around human habitations. Houseflies are capable of carrying over 100 pathogens, including but typhoid, cholera, salmonella, bacillary dysentery, anthrax, opthalmia as well as parasitic worms, and they may transmit disease-carrying agents such as shigella spp. bacteria, Escherichia coli and Vibrio comma. Houseflies may be found around human habitations, and they have a tendency to aggregate and be difficult to dispel.

Humans have employed various methods in the past to attempt to ward off houseflies with limited success. For example, chemical options (such as Raid, Black Flag, Exciter, Vapona, and Purge III) have been used, but chemical options may not be as desirable as they tend to introduce toxins into the environment that may harm and/or repel beneficial insects and/or birds in the vicinity of use and/or may be harmful to humans that may be in direct contact with them. Chemical options also may have unpleasant odors and/or may have a limited time frame for effectiveness. Traps (such as Vector Fly System, Gold Stick Trap and Advantage Fly Trap) have been used; however, these traps tend to have limited effectiveness and also may employ chemical lures that may cause harm to the environment. Sound devices also have been used with limited effectiveness.

### SUMMARY

Embodiments of the present disclosure generally provide a light-based fly repellent that may include a frame having a body positioned within the frame, the body housing a clear liquid, and a stand for supporting a bottom portion of the frame, wherein the clear liquid may refract light and repel flies from an area where the repellent may be positioned. The stand may include at least one supporting area to removably receive the frame. The stand also may include at least one flat surface such that the stand may be placed on a table. The frame may removably receive the body or the frame may be integrally formed with the body. The body may be formed from a clear or lightly color-tinted material. The clear liquid in the body may be selected from the group comprising tap water, distilled water, hydrogen peroxide, acetone, ethyl acetate, isopropyl alcohol, and/or methyl alcohol. The body also may include a nozzle for receiving the clear liquid and a cap to seal the nozzle.

Other embodiments of the present disclosure may provide a light-based fly repellent that may include a frame having a body positioned within the frame, the body housing a clear liquid and the body having a nozzle for receiving the clear liquid, a cap to seal the nozzle, and at least one tab affixed to a portion of the repellent to hang the repellent in an area where houseflies are located, wherein the clear liquid may refract light and repel flies from the area where the repellent may be hung. The at least one tab may be affixed to the nozzle, a top portion of the frame, and/or the cap. The at least one tab may include a mounting hole. The frame may removably receive the body or the frame may be integrally formed with the body. The body may be formed from a clear material or a lightly color-tinted material. The clear liquid may be selected from the group comprising tap water, distilled water, hydrogen peroxide, acetone, ethyl acetate, isopropyl alcohol, and/or methyl alcohol.

Additional embodiments of the present disclosure may provide a method for light-based fly repelling that may include providing a frame having a body positioned within the frame, filling the body with a clear liquid, placing the frame with the body in an area unobstructed from light where flies are located, and refracting light through the body and repelling flies from the area. The clear liquid may be selected from the group comprising tap water, distilled water, hydrogen peroxide, acetone, ethyl acetate, isopropyl alcohol, and/or methyl alcohol. The frame and the body may be placed in the area by affixing a bottom portion of the frame to a stand, hanging the frame using a tab attached to the frame, hanging the frame using a tab attached to a nozzle attached to the body, and/or hanging the frame using a tab attached to a cap on the nozzle attached to the body.

### BRIEF DESCRIPTION OF THE DRAWINGS

For a more complete understanding of this disclosure and its features, reference is now made to the following description, taken in conjunction with the accompanying drawing, in which:

FIG. 1 depicts a stand-based fly repellent according to an embodiment of the present disclosure; and

FIG. 2 depicts a hanging fly repellent according to an embodiment of the present disclosure.

### DETAILED DESCRIPTION

The present disclosure is generally directed to light-based fly repellents and methods of making same. More specifically, light-based fly repellents according to embodiments of the present disclosure may refract light and disturb the optical perception of houseflies, thereby causing the houseflies to flee the vicinity of the repellent. Light may be refracted and the optical perception of houseflies may be disturbed through use of a clear or lightly color-tinted liquid enclosed in a sealed clear or lightly color-tinted body. When natural light (such as sunlight) or light available from other sources (such as a lamp or porch light) may contact the repellent, houseflies may be influenced not to aggregate around the area where the repellent may be positioned.

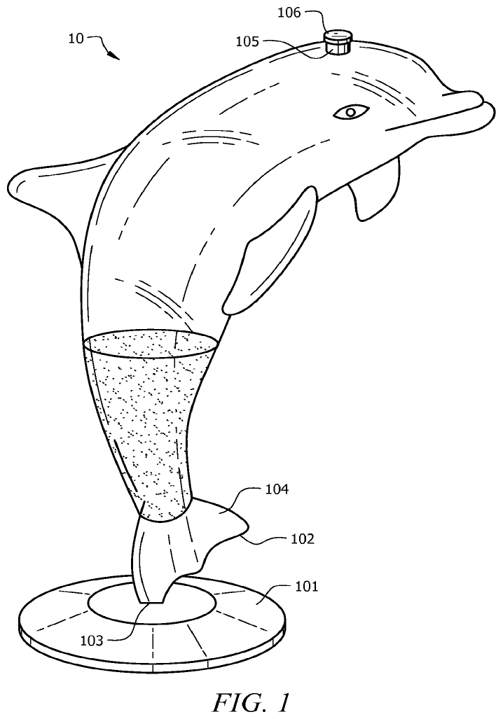

FIG. 1 depicts stand-based fly repellent 10 according to an embodiment of the present disclosure. Repellent 10 may include stand 101 that may support frame 102. Stand 101 may be formed from solid molded plastic; however, it should be appreciated that stand 101 may be formed from other materials, including but not limited to metals, composites, or other plastics, without departing from the present disclosure, as long as the material is sufficiently sturdy to support frame 102. Stand 101 may be comprised of a flat piece of material having at least one supporting area 103, such as a groove, a clip or other fastener, to receive frame 102 or such that frame 102 may be receivably attached to stand 101. It should be appreciated that while frame 102 is depicted as attaching to or being received by stand 101 in the center portion of stand 101 at supporting area 103, frame 102 may be attached to or received by stand 101 at other positions on stand 101 without departing from the present disclosure. It also should be appreciated that stand 101 may be configured to receive or attach to more than one frame 102 without departing from the present disclosure. Stand 101 may include at least one flat surface such that stand 101 may be positioned on a table or other flat surface, for example, a patio/picnic table. Additionally or alternatively, stand 101 may be hollow such that it may be filled with liquid and/or solid material to provide weight and stability in positioning repellent 10.

Frame 102 may be formed from a sturdy material, such as solid molded plastic. However, it should be appreciated that frame 102 may be formed from other materials, such as composites or lighter metals, provided that frame 102 may receive body 104. Frame 102 also may be soft-welded according to embodiments of the present disclosure. Frame 102 may generally be clear or lightly color-tinted to provide for maximum light refraction by repellent 10. However, frame 102 may be formed from other materials, such as metal, provided that the width of frame 102 is minimal compared to the surface area of body 104 such that it does not detract from the light refraction properties of body 104. Frame 102 may assume a variety of shapes and sizes. In FIG. 1, frame 102 is in the shape of a dolphin. However, frame 102 may be formed in a variety of shapes, including but not necessarily limited to, circles, ovals, triangles, squares, stars, states, birds, animals, and flags without departing from the present disclosure. Regardless what shape frame 102 may assume, the shape of frame 102, however, should provide sufficient surface area for light refraction.

Body 104 may be a solid or soft chamber that fits within frame 102. It should be appreciated that in some embodiments of the present disclosure body 104 may be integrally formed with frame 102. However, in other embodiments of the present disclosure, body 104 may be a separate component from frame 102 and may be removably inserted into or affixed to frame 102 at the time of use. In further embodiments of the present disclosure, body 104 may be removably inserted into or affixed to different shapes of frame 102 depending on the shape of frame 102 that may be desired. Body 104 may be formed from a plastic material or other material that may be generally translucent, clear, or lightly color-tinted.

Body 104 may include nozzle 105 such that body 104 may be filled with a clear liquid at or around the time of use of repellent 10. Clear liquids that may be injected or inserted into body 104 may include but are not limited to tap water, distilled water, isopropyl alcohol, methyl alcohol, hydrogen peroxide, acetone, ethyl acetate, and/or combinations of such liquids. Nozzle 105 may be formed from a hard molded plastic or other similar material and may include screw-top cap 106 or other similar removable covering for nozzle 105 for filling and then sealing body 104.

In use, repellent 10 may be placed on a surface in an area where it may be desirable to deter the presence of houseflies. Such an area should be unobstructed from light, natural or otherwise. According to embodiments of the present disclosure, repellent 10 may be placed on a table on a patio or in an outdoor area of a human habitation. As an example, repellent 10 may be placed on a table near the door to a house to deter houseflies from entering the house. Body 104 of repellent 10 may be filled with a clear liquid through nozzle 105. Cap 106 may be sealed upon filling body 104. Light may pass through body 104 of repellent 10 and be refracted by the presence of the clear liquid in body 104 such that the optical perception of houseflies in the vicinity of repellent 10 may be disturbed, effectively repelling houseflies from the area where repellent 10 may be positioned.

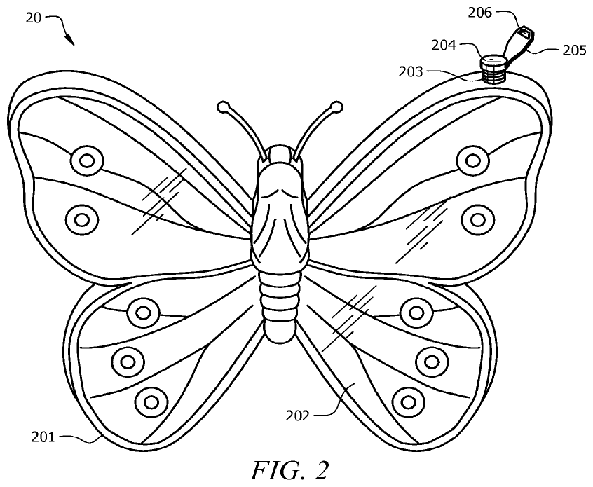

FIG. 2 depicts hanging fly repellent 20 according to an embodiment of the present disclosure. Similar to repellent 10 depicted in FIG. 1, repellent 20 may include frame 201. Frame 201 may be formed from a sturdy material, such as solid molded plastic. However, it should be appreciated that frame 201 may be formed from other materials, such as composites or lighter metals, provided that frame 201 may receive body 202. Frame 201 also may be soft-welded according to embodiments of the present disclosure. Frame 201 may generally be clear or lightly color-tinted to provide for maximum light refraction by repellent 20. However, frame 201 may be formed from other materials, such as metal, provided that the width of frame 201 is minimal compared to the surface area of body 202 such that it does not detract from the light refraction properties of body 202. Frame 201 may assume a variety of shapes and sizes. In FIG. 2, frame 201 is in the shape of a butterfly. However, frame 201 may be formed in a variety of shapes, including but not necessarily limited to, circles, ovals, triangles, squares, stars, states, birds, animals, and flags without departing from the present disclosure. Regardless what shape frame 201 may assume, the shape of frame 201, however, should provide sufficient surface area for light refraction.

Body 202 may be a solid or soft chamber that fits within frame 201. It should be appreciated that in some embodiments of the present disclosure body 202 may be integrally formed with frame 201. However, in other embodiments of the present disclosure, body 202 may be a separate component from frame 201 and may be removably inserted into or affixed to frame 201 at the time of use. In further embodiments of the present disclosure, body 202 may be removably inserted into or affixed to different shapes of frame 201 depending on the shape of frame 201 that may be desired. Body 202 may be formed from a plastic material or other material that may be generally translucent, clear, or lightly color-tinted.

Body 202 may include nozzle 203 such that body 202 may be filled with a clear liquid at or around the time of use of repellent 20. Clear liquids that may be injected or inserted into body 202 may include but are not limited to tap water, distilled water, isopropyl alcohol, methyl alcohol, hydrogen peroxide, acetone, ethyl acetate, and/or combinations of such liquids. However, it should be appreciated that lightly color-tinted liquids also may be used according to embodiments of the present disclosure. As an example, a clear liquid such as distilled water may be colored using food coloring to make repellent 20 have a more appealing color without departing from the present disclosure. Nozzle 203 may be formed from a hard molded plastic or other similar material, and may include screw-top cap 204 or other similar removable covering for nozzle 203 for filling and then sealing body 202.

Repellent 20 may be hung using tab 205 that may be affixed to nozzle 203. Additionally or alternatively tab 205 may be affixed to a top portion of frame 201 or to cap 204 without departing from the present disclosure. Tab 205 may extend upward and may include a hole so that it may be hung. Tab may be formed, for example, from a sturdy plastic or composite material.

In use, repellent 20 may be suspended with a light line, such as fishing tackle, that may be attached to a nail or bolt affixed, for example, around a door opening or to a tree limb that may be in an area where it may be desirable to deter the presence of houseflies. The light line may be threaded through mounting hole 206 in tab 205 and then affixed to a nail or bolt according to embodiments of the present disclosure. However, it should be appreciated that other methods for removably hanging repellent 20 may be used without departing from the present disclosure. Wherever repellent 20 may be hung, it should be hung in an area that is unobstructed from light, natural or otherwise. Body 202 of repellent 20 may be filled with a clear liquid through nozzle 203. Cap 204 may be sealed upon filling body 202. Light may pass through body 202 of repellent 20 and be refracted by the presence of the clear liquid in body 202 such that the optical perception of houseflies in the vicinity of repellent 20 may be disturbed, effectively repelling houseflies from the area where repellent 20 may be positioned.

Light-based fly repellents according to embodiments of the present disclosure may provide a non-toxic form of repelling houseflies by refracting light and/or disturbing the optical perception of houseflies in areas where houseflies may commonly be present, such as on patios, around outside doorways, windows, or around areas of human habitation. Embodiments of the present disclosure may provide an effective, non-toxic barrier to flies at building entrances and/or around windows. Further, recyclable or reusable materials may be used to form the frame, stand, and/or body of repellents according to embodiments of the present disclosure.

Light-based repellents according to embodiments of the present disclosure may provide repelling action across a narrow-band, thereby focusing on the common housefly. Such repellents may be generally inert, thereby creating little to no environmental dispersion or contamination. Light-based fly repellents according to embodiments of the present disclosure may be desirable as they do not rely on an electrical current to function and can therefore be more portable. They also may be aesthetically pleasing when placed in an outdoor area as they are generally clear or lightly color-tinted. As light-based fly repellents according to embodiments of the present only repel or deter houseflies and do not kill them, these repellents may maintain environment balance by temporarily relocating houseflies (or causing houseflies to avoid the area) rather than killing or trapping them. Further, these repellents may be light, small and mobile, thereby allowing a user to move such repellents to different locations as desired. Accordingly, repellents according to embodiments of the present disclosure may provide an effective yet ecologically sound form of fly repellents that may be inexpensive for a consumer and simple in operation.

While this disclosure may address repelling or deterring the presence of houseflies, it should be appreciated that light-based repellents according to embodiments of the present disclosure may be used to repel other insects without departing from the present disclosure. Further, while the present disclosure is largely directed to repelling or deterring the presence of houseflies around a human habitation, it should be appreciated that light-based fly repellents according to embodiments of the present disclosure may be employed in any area where houseflies or other similar insects may be located and it may be desirable to repel them.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A light-based fly repellent comprising:
a frame having a soft body positioned within the frame, the body selectively molded to assume the shape of the frame and housing a clear liquid and the body having a nozzle for receiving the clear liquid and a cap to seal the nozzle; and
at least one tab affixed to the cap to hang the repellent in an area where houseflies are located, wherein the clear liquid refracts light and repels flies from the area where the repellent is hung.

2. The light-based fly repellent of claim 1 wherein the at least one tab is additionally affixed to a top portion of the frame.

3. The light-based fly repellent of claim 1 wherein the at least one tab includes a mounting hole.

4. The light-based fly repellent of claim 1 wherein the frame removably receives the body.

5. The light-based fly repellent of claim 1 wherein the frame is integrally formed with the body.

6. The light-based fly repellent of claim 1 wherein the body is formed from a clear material.

7. The light-based fly repellent of claim 1 wherein the body is formed from a lightly color-tinted material.

8. The light-based fly repellent of claim 1 wherein the clear liquid is selected from the group comprising:
tap water, distilled water, hydrogen peroxide, acetone, ethyl acetate, isopropyl alcohol, and methyl alcohol.

9. The light-based fly repellent of claim 1 further comprising:
a stand having a flat surface positioned parallel to a surface and at least one supporting area on top of the flat surface to removably receive the bottom portion of the frame, wherein the clear liquid refracts light and repels flies from an area where the repellent is positioned.
